(19) United States
(12) Patent Application Publication
(10) Pub. No.: US 2005/0232360 A1
(43) Pub. Date: Oct. 20, 2005

(54) Motion estimation apparatus and method with optimal computational complexity

(75) Inventor: Hyun Il Byun, Seoul (KR)

Correspondence Address: HARNESS, DICKEY & PIERCE, P.L.C., P.O. BOX 828, BLOOMFIELD HILLS, MI, 48303, US

(73) Assignee: C and S Technology Co., Ltd., Seoul (KR)

(21) Appl. No.: 11/073,500

(22) Filed: Mar. 4, 2005

(30) Foreign Application Priority Data
Apr. 3, 2004 (KR) 10-2004-23168

(51) Int. Cl. H04N 7/12

(52) U.S. Cl. 375/240.17; 375/240.16; 375/240.12; 375/240.24

(57) ABSTRACT

Disclosed are a motion estimation (ME) apparatus and method using a fast search algorithm for a motion vector (MV) that can significantly reduce the number of computations by making use of the fast search algorithm rather than a conventional full search algorithm and that can allow a user to set a computational complexity level. The fast MV search algorithm causes image degradation of approximately 0.5 dB at most, but can significantly reduce the number of computations. As the number of computations of an ME circuit can be adjusted by input computational complexity parameters, the efficiency of a pipeline structure in which texture encoding and ME are performed in a parallel fashion can be maximized.

### BACKGROUND OF THE INVENTION

1. Field of the Invention

The present invention relates generally to a motion estimation (ME) apparatus and method. More particularly, the present invention relates to an ME apparatus and method using a fast search algorithm for a motion vector (MV) that can significantly reduce the number of computations by making use of the fast search algorithm rather than a conventional full search algorithm and that can allow a user to set a computational complexity level, such that the ME apparatus and method can be easily used in various applications.

2. Description of the Related Art

Motion estimation (ME) techniques are used to obtain high compression efficiency by removing the temporal redundancy within video. The ME technique is being adopted to compress or encode video in international standards such as Moving Picture Experts Group (MPEG), H.263, etc.

Because an ME operation requires a lot of computations in a video compression process, it significantly influences the overall performance of a video compression system. It is important for the ME operation to be quickly performed using an optimum algorithm at low consumption power such that the performance of video compression can be improved.

In implementing a circuit for the ME, conventional techniques has put a focus to reduce the number of bits by means of a full search algorithm that searches for the best-matched block from a search area in the previous frame. Because the conventional techniques require a lot of computations and a large circuit area, significant cost and power are required to process real-time video in a state in which a size of video and an amount of data increase gradually.

Because a computational complexity level is fixed in a conventional ME apparatus, a user cannot implement a relatively high frame rate when desiring to perform the increased number of ME operations although the number of bits increases according to various applications.

FIG. 1 is a block diagram illustrating a conventional encoder for encoding each macroblock (with a size of 16×16 pixels of an image) according to the Moving Picture Experts Group 4 (MPEG-4) standard.

Referring to FIG. 1, the encoder 100 includes a motion estimation (ME) block 101, a motion compensation (MC) block consisting of MC(−) blocks 102a and 102b, a discrete cosine transform/quantization (DCT/Q) block 103a, an AC/DC prediction (ADP) block 104, a variable length coding (VLC) block 105, and an inverse Q/inverse DCT (IQ/IDCT) block 103b.

The ME block 101 performs a task for predicting motion by comparing luminance components of previous and current frames. A result of the prediction task is output as a motion vector (MV). The MV represents the displacement between the current frame and the previous frame on a macroblock-by-macroblock or block-by-block basis. Here, the block consists of 8×8 pixels. Because temporal redundancy is removed using the ME, the amount of encoding can be reduced.

The MV is information indicating directivity of each point of a frame displayed on an image. The MV is decided by finding a position of the best-matched block from the previous frame on the basis of a block (or macroblock) located at a predetermined coordinate in the current frame. A different area between two temporarily neighboring frames is referred to a search area. This search area is located on the previous frame. A position of a block most similar to a macroblock of the current frame is searched for from the search area.

A method for deciding an MV by searching for the best-matched block from the search area computes a difference between a pixel within the search area of the previous frame and a pixel within the macroblock of the current frame and then computes a sum of absolute differences (SAD). Then, the method searches for a position corresponding to the minimum SAD and decides the MV according to the searched position. That is, when a reference point of a macroblock of the current frame is (x,y) and a reference point of a block of the previous frame in the search area most similar to the reference point of the macroblock of the current frame is (x+u,y+v), the Mv is decided to be (u,v).

The MC block and the DCT/Q block 103a except for the ME block 101 perform a texture encoding operation. The texture encoding operation is carried out on four luminance blocks and two chrominance blocks included in one macroblock.

The MC(−) block 102a performs a subtraction task for subtracting a pixel value of the previous frame from a pixel value of the current frame using an MV produced by the ME block 101. In this task, only pixel differences between the previous and current frames are left, such that the amount of information to be encoded is reduced.

After the subtraction task of the MC(−) block 102a, the DCT/Q block 103a converts spatial domain data into frequency domain data and then performs a quantization operation to reduce the amount of information.

The ADP block 104 produces a difference value between AC/DC coefficients of adjacent blocks. This operation is carried out only on an intra macroblock, thereby reducing spatial redundancy and the amount of encoding.

The VLC block 105 carries out a VLC operation on data to generate a final bitstream.

The MC(+) block 102b and the IQ/IDCT block 103b recover a block image by means of the inverse process of a process of the MC(−) block 102a and the DCT/Q block 103a, and then produce data to be decoded by a decoder. Since the data is used in the ME for a next frame, the decoder and encoder can predict and compensate motion using identical frames.

FIG. 2 illustrates a macroblock pipeline structure for motion estimation (ME) and texture encoding in the conventional encoder.

Referring to FIG. 2(a), the ME is first performed in an encoding operation on each macroblock, and an intermediate processing operation is performed by a central processing unit (CPU). Subsequently, the texture encoding operation is performed. Finally, the CPU processes a result of the texture encoding operation. Because the ME requires the longest time period and is performed independent of other tasks, it is efficient that the ME is performed in the pipeline structure.

FIG. 2(b) illustrates a case where a large quantization coefficient is applied as compared with FIG. 2(a).

When a quantization coefficient is large, a time period required for texture encoding is conventionally reduced. A computation time in a conventional motion estimation (ME) apparatus is not affected by the quantization coefficient. However, it can be seen that the ME is performed in an interval “d” as illustrated in FIG. 2(b) even after texture encoding operations on a pipeline from Macroblock 1 to Macroblock N-2 illustrated in FIG. 2(b) is completed. This process degrades the efficiency of the macroblock pipeline structure.

FIG. 3 is a block diagram illustrating a conventional motion estimation apparatus. The ME apparatus 200 is constructed by frame memories 202 and 204, a multiplexer (MUX) block 206, a processing element (PE) block 208, a comparator (COM) block 210, and a state control block 212.

The frame memory 202 stores data of a previous frame, and the frame memory 204 stores data of a current frame. The frame memories 202 and 204 receive frame data from an external memory (not shown).

The MUX block 206 is responsible for distributing the data from the frame memories 202 and 204 to the PE block 208. The PE block 208 processes a task for computing SADs for a plurality of MV candidates in a parallel fashion and implements a full search requiring a lot of computations.

The COM block 210 outputs the minimum SAD of the SADs computed by the PE block 208 and an MV corresponding to the minimum SAD.

The state control block 212 controls an overall operation of the ME apparatus 200.

FIG. 4 is a flowchart illustrating a conventional ME process.

In step S100, a macroblock-based ME process is performed. SADs are computed for pixels (x,y) within a motion search area, and a point corresponding to the minimum SAD is searched for. In this case,

$$SAD ( x , y ) = {\sum }_{i = 0}^{15} {\sum }_{j = 0}^{15} \vert {C}_{i , j} - {P}_{i + x , j + y} \vert ,$$

where C_{i,j} is a pixel value of a current frame, and P_{i,j} is a pixel value of a previous frame.

In step S102, a block-based ME process is performed. The ME process is performed for ±2 pixels around an MV computed in step S100. In this case,

$$SAD ( x , y ) = {\sum }_{i = 0}^{7} {\sum }_{j = 0}^{7} \vert {C}_{i , j} - {P}_{i + x , j + y} \vert .$$

In step S104, a parameter is computed to make a determination as to whether a current macroblock is encoded as an intra or inter macroblock.

First, a mean pixel value MB_mean of the current macroblock is computed by the following Equation 1, and an encoding decision parameter A is computed by the following Equation 2.

$$\begin{matrix}MB\_mean = ( {\sum }_{i = 0 , j = 0}^{15 , 15} {C}_{i , j} ) / 256 & ( 1 ) \\ A = {\sum }_{i = 0 , j = 0}^{15 , 15} \vert {C}_{i , j} - MB\_mean \vert & ( 2 )\end{matrix}$$

In step S106, a determination is made as to whether the current macroblock is an intra or inter macroblock by the following Equation 3 using the parameter A computed in step S104 and the SADs computed in steps S100 and S102. Here, when the following Equation 3 is true, it is determined that the current macroblock is an intra macroblock.
A<(SAD−256) (3)

When the current macroblock is the intra macroblock, an MV is set to 0 in step S114 and then the ME process is terminated.

However, when the current macroblock is the inter macroblock, the process proceeds to step of half-pixel ME.

In step S108, a half-pixel ME process is performed in a macroblock unit. SADs are computed for 8 half-pixel MVs in the up, down, left, right, and diagonal directions of the MV computed in step S100, and an MV with the minimum SAD is searched for.

In step S110, a half-pixel ME process based on a block unit searches for an MV with the minimum SAD around the MV computed in step S102.

In step S112, a determination is made as to whether an MV is used in a macroblock or block unit, using the following Equation 4. In the following Equation 4, SAD₁₆ is an SAD produced from a result of macroblock-based ME, and SAD₈ is an SAD produced from a result of block-based ME.

$${SAD}_{16} < {\sum }_{4 blocks} {SAD}_{8} - 128 \qquad ( 4 )$$

Conventional ME circuits based on the full-search algorithm as stated above can easily perform a control operation and can perform a compression operation with the minimum amount of encoding. However, the conventional ME circuits increase a circuit area and power consumption.

Moreover, because the computational complexity is fixed such that the amount of encoding is minimized, the conventional ME circuits cannot implement a high frame rate when the user wants to perform a large number of ME operations while increasing the amount of encoding and decreasing the number of computations.

Further, when a quantization coefficient is large, a time period required for texture encoding is reduced. Even though a time period required for texture encoding is reduced, the overall rate cannot be improved if a time period required for ME is not reduced according to the pipeline structure as illustrated in FIG. 2.

### SUMMARY OF THE INVENTION

Therefore, the present invention has been made in view of the above and other problems, and it is an object of the present invention to provide a motion estimation (ME) apparatus and method using a fast search technique for a motion vector (MV) that can significantly reduce the number of computations by making use of the fast search algorithm rather than a conventional full search algorithm and that can allow a user to set a computational complexity level, such that the ME apparatus and method can be easily used in various applications.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram illustrating a conventional encoder for encoding each macroblock (with a size of 16×16 pixels of an image) according to the Moving Picture Experts Group 4 (MPEG-4) standard;

FIG. 2 illustrates a macroblock pipeline structure for motion estimation (ME) and texture encoding in the conventional encoder;

FIG. 3 is a block diagram illustrating a conventional motion estimation apparatus;

FIG. 4 is a flowchart illustrating a conventional ME process;

FIG. 5 is a block diagram illustrating an ME apparatus in accordance with the present invention;

FIG. 6 is a block diagram illustrating the detailed structure of a motion vector (MV) management block illustrated in FIG. 5;

FIG. 7 is a block diagram illustrating the detailed structure of a processing element (PE) block illustrated in FIG. 5;

FIG. 8 is an overall flowchart illustrating an ME method in accordance with the present invention;

FIGS. 9A to 9C are detailed flowcharts illustrating an ME process in accordance with the present invention; and

FIG. 10 illustrates an example of comparing an inventive pipeline structure and a conventional pipeline structure for video encoding.

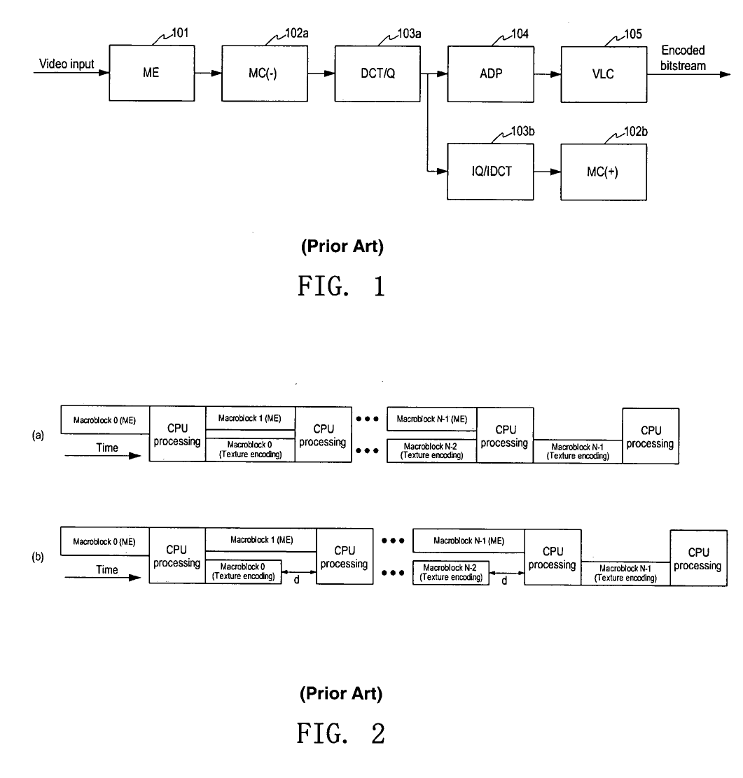

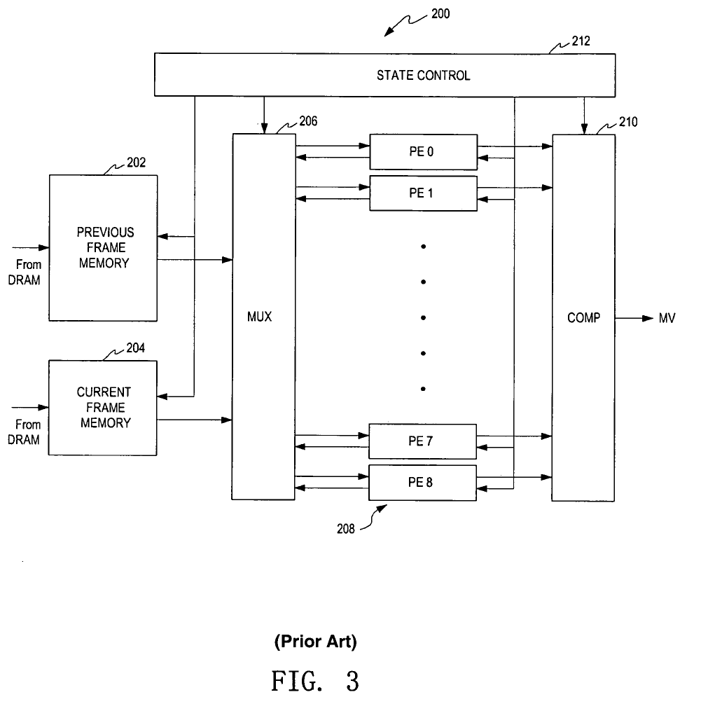

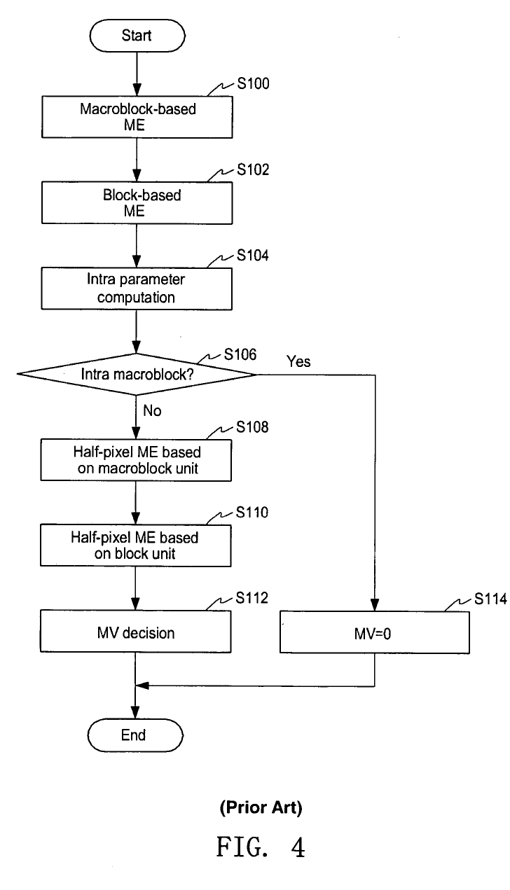

### DESCRIPTION OF THE PREFERRED EMBODIMENTS

Before a detailed description of the present invention is given, technical terminology used in the present invention will be described.

A macroblock is a unit of 16×16 pixels. One frame is divided into a plurality of macroblocks. Each macroblock is segmented into 4 luminance blocks and 2 chrominance blocks. Each block consists of 8×8 pixels.

An intra-mode is an encoding mode using only a current frame regardless of a previous frame.

An inter-mode is a mode for encoding a difference between a previous frame and a current frame, and a motion vector (MV). The inter-mode is divided into 1MV and 4MV modes.

The 1MV mode is a mode with an MV per macroblock in the inter-mode.

The 4MV mode is a mode with an MV per luminance block in the inter-mode. The 4MV mode has a total of 4 MVs in the macroblock.

Embodiments of the present invention will be described in detail herein below with reference to the accompanying drawings.

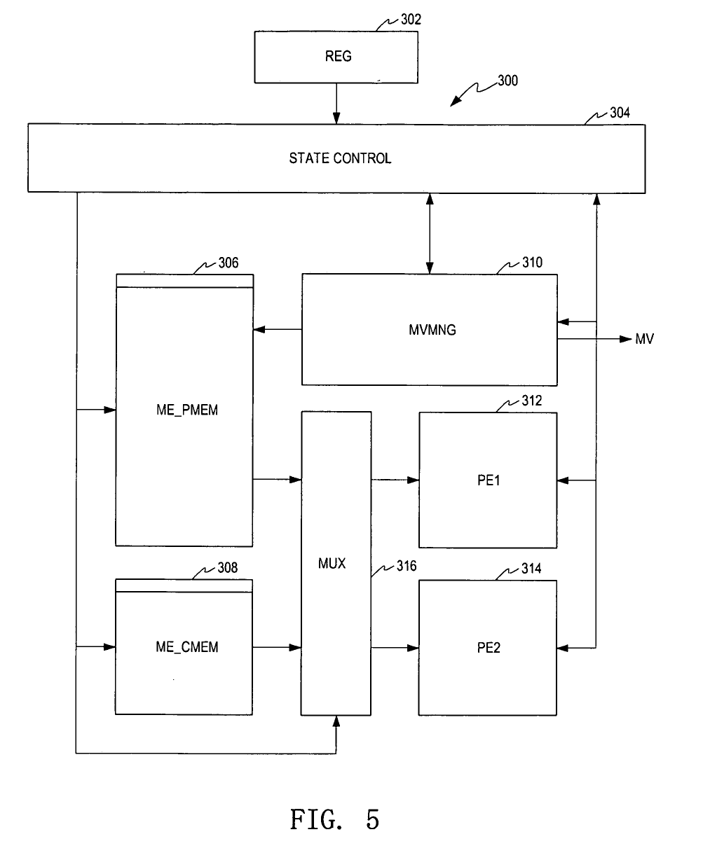

FIG. 5 is a block diagram illustrating a motion estimation (ME) apparatus in accordance with the present invention. The ME apparatus includes a register (REG) block 302, a state control (STATE CONTROL) block 304, frame memories (ME_PMEM and ME_CMEM) 306 and 308, an MV management (MVMNG) block 310, processing element (PE) blocks 312 and 314, and a multiplexer (MUX) block 316.

The REG block 302 registers or stores a plurality of parameters necessary for ME. The parameters stored in the REG block 302 include MV prediction values, computational complexity parameters, and user setup values.

MV Prediction Values

The MV prediction values used in macroblock-based ME include MV Prediction Value 0 of (MVPX0, MVPY0) corresponding to an MV value of a block located at (0, 0), MV Prediction Value 1 of (MVPX1, MVPY1) corresponding to a median value between Prediction Values 2, 3, and 4, MV Prediction Value 2 of (MVPX2, MVPY2) corresponding to an MV value of a block located in the up direction, MV Prediction Value 3 of (MVPX3, MVPY3) corresponding to an MV value of a block located in the up/right diagonal direction, and MV Prediction Value 4 of (MVPX4, MVPY4) corresponding to an MV value of a block located in the left direction.

Computational Complexity Parameters

The computation complexity parameters include a value EN4 indicating whether or not an operation associated with the 4MV mode is performed, a value LW4 indicating whether block-based ME around an MV found in macroblock-based ME is performed for +1 or ±2 pixels, a value IPO indicating whether the ME is performed only for integer pixels, and a value MEP indicating whether half-pixel ME is performed in the 1MV or 4MV mode after the 1MV or 4MV mode is decided.

User Setup Values

The user setup values include a value of THR_{INTRA} to be subtracted from an SAD when the intra-mode or inter-mode is decided, and a value of THR_{1MV} to be subtracted from an SAD when the 1MV or 4MV mode is decided.

The STATE CONTROL block 304 controls an overall operation of the ME apparatus.

The ME_PMEM 306 stores partial data necessary for ME among previous frame data.

The ME_CMEM 308 stores partial data necessary for ME among current frame data.

The MVMNG block 310 manages and outputs MVs.

The PE (PE1) block 312 computes SADs on the basis of data received from the ME_PMEM 306 and the ME_CMEM 308.

The PE (PE2) block 314 can perform a function of the PE (PE1) block 312, and can produce an intra parameter, that is, a mean value between current macroblock pixels.

The MUX block 316 performs a function for appropriately distributing data of the ME_PMEM 306 and the ME_CMEM 308 to the PE blocks 312 and 314.

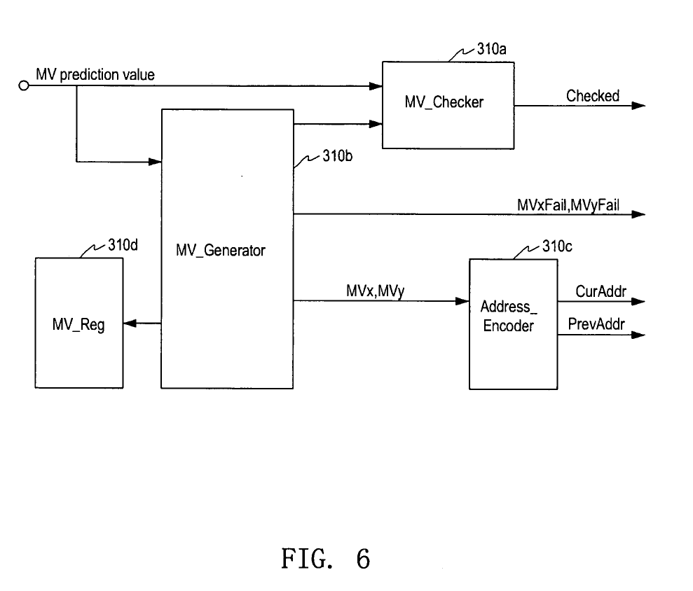

FIG. 6 is a block diagram illustrating the detailed structure of the MVMNG block illustrated in FIG. 5. The MVMNG block includes an MV checker (MV_Checker) block 310a, an MV generator (MV_Generator) block 310b, an address encoder (Address_Encoder) block 310c, and an MV register (MV_Reg) block 310d.

The MV_Checker block 310a checks whether or not an SAD to be currently computed for an MV has already been computed. If the SAD to be currently computed has already been computed, the MV_Checker block 310a informs the STATE CONTROL block 304 of the fact that the SAD to be currently computed for the MV has already been computed, through a “Checked” parameter.

Because most of the fast motion estimation algorithms are started from several prediction points, differently from a full search, an SAD is repeatedly computed even though some of the prediction points are adjacent or matched to each other.

The MV_Checker block 310a prevents a duplicate SAD from being computed.

The MV_Generator block 310b generates an MV necessary for computing a current SAD on the basis of MV prediction values of (MVPX0, MVPY0, . . . , MVPX4, MVPY4). When an MV value of (MVx, MVy) generated to compute the SAD is outside a search range, the MV_Generator block 310b informs the STATE CONTROL block 304 of the fact that the generated MV value is outside the search range, through “MVxfail” and “MVyfail” parameters.

The Address_Encoder block 310c generates an address necessary for reading data from the ME_PMEM 306 and the ME_CMEM 308 on the basis of the generated MV value of (MVx, MVy). Here, a “CurAddr” parameter is an address for reading pixel data from the ME_CMEM 308 and a “PrevAddr” parameter is an address for reading pixel data from the ME_PMEM 306.

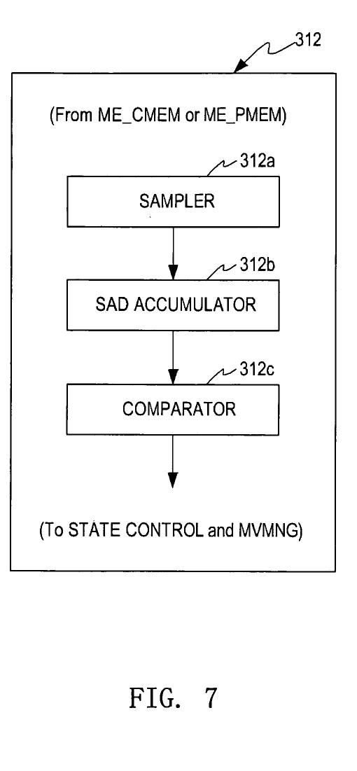

FIG. 7 is a block diagram illustrating the detailed structure of the PE block illustrated in FIG. 5. The PE block includes a sampler 312a, an SAD accumulator 312b, and a comparator 312c.

The sampler 312a samples pixel data necessary for an SAD computation. Pixel data of a current frame is simply read from the ME_CMEM 308, but pixel data of a previous frame must be read as pixel data of a point shifted by an MV value currently tested, from the ME PMEM 306.

The SAD accumulator 312b computes an SAD of a block currently tested by a computation, subtracts the pixel data of the previous frame from the pixel data of the current frame received from the sampler 312a, and accumulates a result of the subtraction.

The comparator 312c compares SADs computed by the SAD accumulator 312b. The comparator 312c detects the minimum SAD of the SADs for MVs, and compares the minimum SAD with a newly computed SAD. The STATE CONTROL block 304 is notified of a result of the comparison. The STATE CONTROL block 304 uses the comparison result to appropriately control an ME operation.

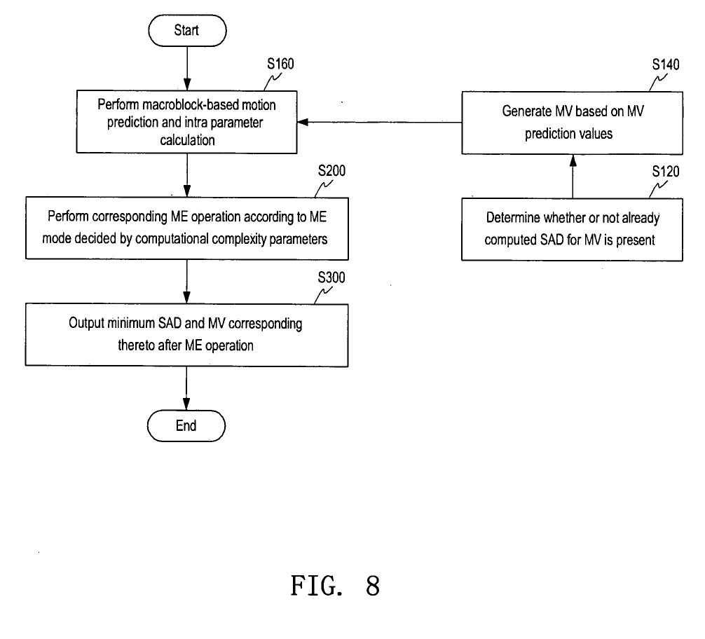

FIG. 8 is an overall flowchart illustrating an ME method in accordance with the present invention.

First, in step S160, a macroblock-based motion prediction and an intra parameter computation are performed. That is, the minimum SAD of a current macroblock and an MV corresponding thereto are searched for, and a mean value of pixel data of the current macroblock is computed.

Before step S160 is performed, a determination is made as to whether an SAD to be currently computed for an MV has already been computed in step S120. In step S140, the MV with the SAD to be currently computed is generated and a determination is made as to whether the MV with the SAD to be currently computed is outside a search range.

Step S160 uses a fast MV search algorithm. The fast MV search algorithm searches for an MV value with the minimum SAD around the above-mentioned five MV prediction values. That is, the algorithm computes an SAD from (MVPX0, MVPY0), and computes SADs from points within two pixels. When SADs are computed from (MVPX1, MVPY1), . . . , (MVPX4, MVPY4) and points within two pixels thereof, the MV value associated with the minimum SAD becomes a final MV value.

This algorithm can operate at a high rate by performing a search based on an MV of a neighboring block, and can reduce the amount of MV encoding, as compared with other fast ME algorithms. According to a result of experimentation, the fast search algorithm of the present invention is approximately 160 times faster than the full search algorithm. When an image is encoded by an equal number of bits in the fast search algorithm of the present invention and the conventional full search algorithm, only image degradation of approximately 0.5 dB appears in the fast search algorithm of the present invention. The human eye cannot perceive the image degradation of approximately 0.5 dB. The reduced number of computations can maximize the efficiency of adjustment by computational complexity parameters.

In step S160, the PE block 314 computes an intra parameter while the macroblock-based ME process is performed. Because the intra parameter needs only data of a current frame in the above Equations 1 and 2, the PE block 314 can compute the intra parameter using the current frame data input into the PE block 312.

Subsequently, in step S200, the computational complexity parameters are received, and the ME operation on the current frame is carried out in an ME mode decided by the computational complexity parameters.

Subsequently, in step S300, the minimum SAD for a current macroblock and an MV corresponding to the minimum SAD are outputted after the ME operation.

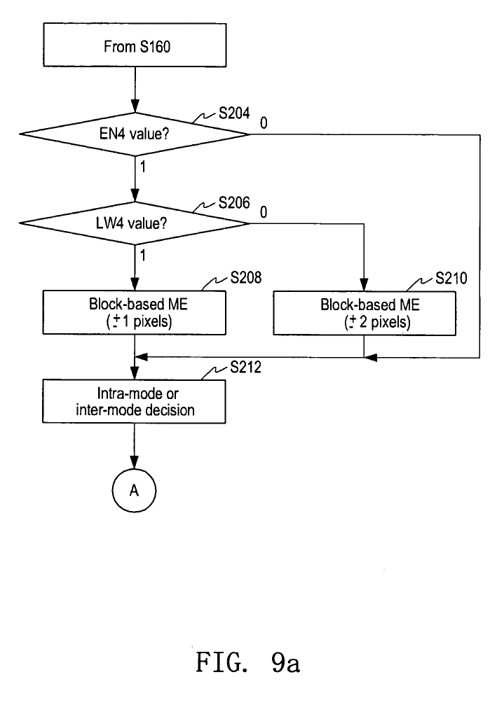

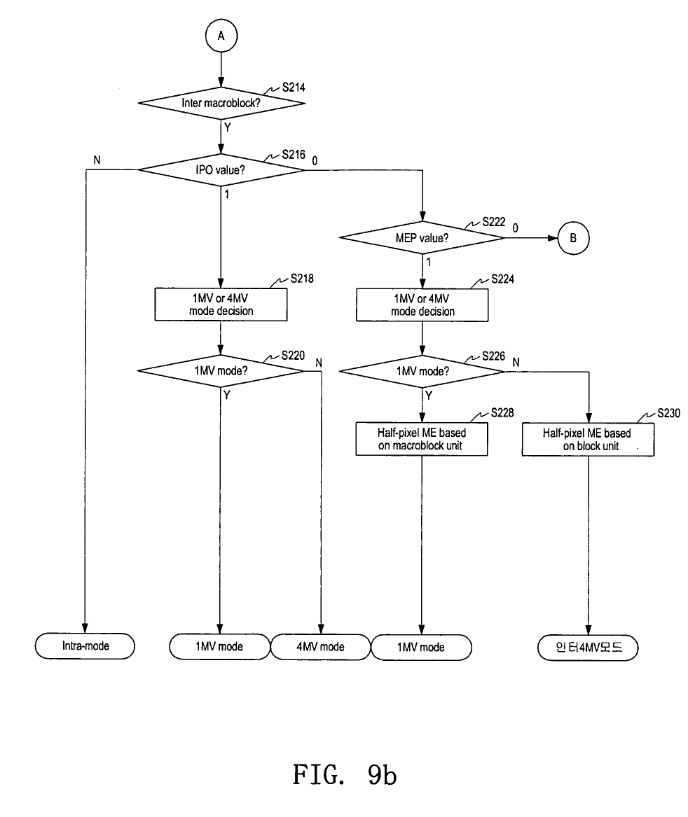

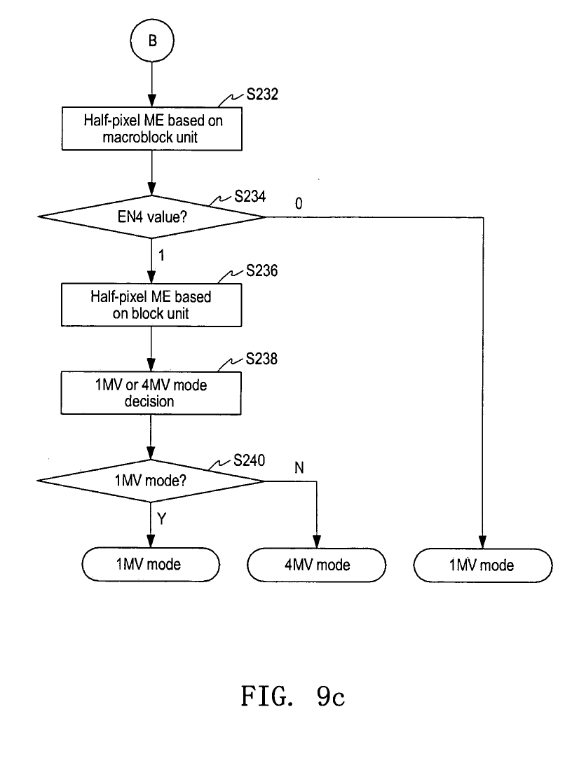

FIGS. 9A to 9C are detailed flowcharts illustrating n ME process in accordance with the present invention.

When the macroblock-based ME is performed and the intra parameter is computed in step S160, the computational complexity parameters are received and the ME operation on the current frame is carried out in an ME mode decided by the computational complexity parameters in step S200. This will be described in detail.

When EN4 is 1 in step S204, the process branches to step S206. However, when EN4 is 0, the process branches to step S210. Here, EN4 is a value indicating whether an operation associated with the 4MV mode is performed as mentioned above.

When LW4 is 1 in step S206, the process branches to step S208. However, when LW4 is 0, the process branches to step S210. Here, LW4 is a value indicating whether block-based ME around an MV found in the macroblock-based ME is performed for ±1 or ±2 pixels.

In step S208, ME is performed for 4 luminance blocks of a current macroblock, and an SAD is computed for an MV in a ±1 pixel range around an MV produced as a result of the macroblock-based ME in step S160.

Step S210 is similar to step S208. A block-based ME range in step S210 is wider than that in step S208. That is, the block-based ME range in step S210 is ±2 pixels.

A time period of step S210 is approximately thrice more than that of step S208. However, the probability of searching for an MV with the minimum SAD in step S210 is higher. Step S208 or S210 can reduce an ME time period because the PE blocks 312 and 314 simultaneously operate.

In step S212, an intra parameter and an SAD are compared according to the following Equation 5, and a determination is made as to whether a macroblock is an intra or inter macroblock. The following Equation 5 is different from the above Equation 3 in that a value to be subtracted from an SAD is variable, and is determined by THR_{INTRA} input from the REG block 302. When the following Equation 5 is true, a mode is decided to be an inter-mode. However, when the following Equation 5 is false, a mode is decided to be an intra-mode.
A<(SAD−THR_{INTRA}) (5)

When the macroblock is an intra macroblock in step S214, an MV is set to 0. However, when the macroblock is an inter macroblock, the process proceeds to step S216.

When IPO is 1 in step S216, the process branches to step S218. However, when IPO is 0 in step S216, the process branches to step S222. Here, IPO is a value indicating whether ME is performed only for integer pixels.

In step S218, a determination is made as to whether different MVs for blocks are set or one MV for a macroblock is set according to the following Equation 6. In the following Equation 6, SAD₁₆ is an SAD produced from a result of the macroblock-based ME, and SAD₈ is an SAD produced from a result of the block-based ME. At this time, the user can directly register a THR_{1MV} value in the REG block 302. The total amount of encoding can be minimized according to various parameters such as the quantization coefficient, etc.

$${SAD}_{16} < {\sum }_{4 blocks} {SAD}_{8} - {THR}_{1 MV} \qquad ( 6 )$$

When the above Equation 6 is true in step S220, the inter-mode is decided as the 1MV mode. However, when the above Equation 6 is false, the inter-mode is decided to be the 4MV mode. A mode decision result in step S218 is stored and the ME process is terminated.

When MEP is 1 in step S222, the process branches to step S224. However, when MEP is 0, the process branches to step S232.

Step S224 is identical with step S218. That is, in step S224, a determination is made as to whether different MVs for blocks are set or one MV for a macroblock is set.

When a mode decision result in step S224 is the 1MV mode in step S226, the process branches to step S228. However, when the mode decision result in step S224 is the 4MV, the process branches to step S230.

In step S228, half-pixel ME based on a macroblock unit is performed. When the half-pixel ME based on the macroblock unit is performed, SADs are computed for 8 half-pixels surrounding the found MV, that is, (−0.5, −0.5), (0, −0.5), (+0.5, −0.5), (−0.5, 0), (+0.5, 0), (−0.5, +0.5), (0. +0.5), and (+0.5, +0.5). Subsequently, when one of the computed SADs is smaller than the SAD computed in step S160, an MV corresponding to the smaller SAD is produced. The half-pixel ME based on the macroblock unit is completed while 5 SADs are computed using both the PE blocks 312 and 314.

In step S230, half-pixel ME based on a block unit performed. Step S230 is different from step S228 in that SADs for 8 half-pixels surrounding the MV outputted from step S208 or S210 are computed for 4 luminance blocks of a macroblock. That is, when an SAD is computed, a size of a data block read in step S230 is a quarter of a size of a data block read in step S228. However, because a read operation is repeated for 4 blocks four times in step S230, a time period taken in step S230 is similar to that taken in step S228. In practice, a time period of step S230 is approximately 30% more than that of step S228, because step S230 has a larger number of operations for reading pixel data in consecutive addresses than step S228.

Step S232 is identical with step S228.

When EN4 is 1 in step S234, the process branches to step S236. However, when EN4 is 0, the inter-mode is decided to be the 1MV mode, and the ME process is terminated.

Step S236 is identical with step S230.

Step S238 is similar to step S218 or S224. However, step S238 is performed after the half-pixel ME based on the block unit is completed.

In step S240, a mode decision result in step S238 is stored. Subsequently, the ME process is terminated.

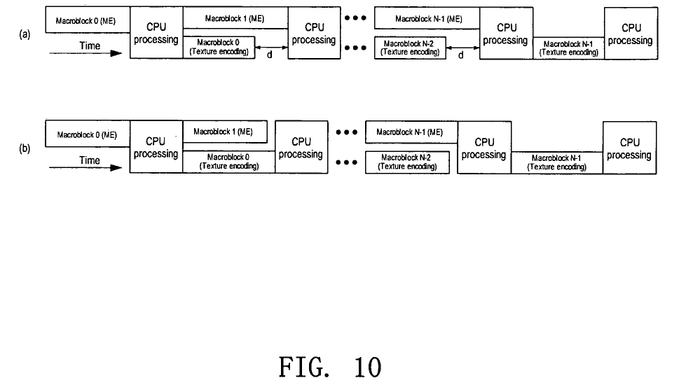

FIG. 10 illustrates an example of comparing an inventive pipeline structure and a conventional pipeline structure for video encoding. Here, a relatively large quantization coefficient is applied.

Referring to FIG. 10(a), when the quantization coefficient is large, a time period taken to perform texture encoding is conventionally reduced, but a time period “d” taken to perform ME is not reduced, such that the overall efficiency of a pipeline structure is degraded.

Referring to FIG. 10(b), the pipeline structure of the present invention can reduce a time period for ME when a time period for texture encoding is reduced. Of course, the reduced ME time can slightly increase the amount of encoding. However, when the quantization coefficient is increased, the amount of encoding is reduced. Moreover, when the quantization coefficient increases, an increase in the amount of encoding is slow according to the reduced number of computations. This has been found by experimentation.

In order to achieve the above-mentioned advantage associated with FIG. 10(b), an apparatus of the present invention receives computational complexity parameters of IPO, EN4, MEP, and LW4 illustrated in the following Table 1. The computational complexity parameters significantly affect the required cycle of an ME circuit. The following Table 1 illustrates an example of the relationship between the computational complexity parameters and the required cycle. The required cycle illustrated in the following Table 1 corresponds to a worst case. An actually required cycle may be shorter than the required cycle illustrated in the following Table 1. As illustrated in the following Table 1, the fastest cycle is thrice faster than the slowest cycle. In case of the fast cycle, the total amount of encoding increases by approximately 10% at most. It has been found by experimentation that a computation rate is fast and an increase in the amount of encoding is reduced when the quantization coefficient is large.

For example, when the quantization coefficient is 8, the amount of encoding increases by approximately 7˜10% in case of IPO of 1 as compared with case of IPO of 0. However, when the quantization coefficient is 28, the amount of encoding increases by approximately 3˜5%. The reason why the required cycle is significantly different according to a change of a computational complexity parameter as illustrated in the following Table 1 is that the macroblock-based ME is quickly performed using the fast MV search algorithm in step S160. If the full search algorithm is used, it cannot achieve the reduced ME time illustrated in the following Table 1 even though some computational complexity parameters illustrated in the following Table 1 are changed.

TABLE 1

| EN4 | IPO | | | Required |
|---|---|---|---|---|
| (Enable | (Integer- | MEP(Pre- | LW4 (Light | cycle (worst |
| 4MV) | Pel Only) | decision) | Weight 4MV) | case) |
| 1 | 0 | 0 | 0 | 4979 |
| 1 | 0 | 1 | 0 | 4222 |
| 1 | 0 | 0 | 1 | 3963 |
| 1 | 1 | — | 0 | 3231 |
| 1 | 0 | 1 | 1 | 3206 |
| 0 | 0 | — | — | 2282 |
| 1 | 1 | — | 1 | 2215 |
| 0 | 1 | — | — | 1522 |

As apparent from the above-description, the present invention provides a number of advantages.

1. A fast MV search is applied to macroblock-based ME. When the amount of encoding in the fast MV search is the same as that in a full search, the fast Mv search causes image degradation of approximately 0.5 dB at most, but can significantly reduce the number of computations. Additionally, the fast MV search can significantly reduce an area of an ME circuit and power consumption.

2. As the number of computations of the ME circuit can be adjusted by input computational complexity parameters, the efficiency of a pipeline structure in which texture encoding and ME are performed in a parallel fashion can be maximized. When a quantization coefficient is large, a time period taken to perform the texture encoding is reduced. In this case, when a time period taken to perform the ME can also be reduced, a time period for performing only the ME can be reduced after texture encoding in an inefficient interval.

3. When it is assumed that a video encoder can encode 10 frames with 4CIF size of 704×576 pixels for one second in a worst case, and encodes an image in a state in which a quantization coefficient is set to a large value of 31, the present invention can reduce the amount of encoding, and thus can reduce a time taken to perform texture encoding and a processing time of a CPU. The conventional technique cannot reduce a time taken to perform ME occupying a lot of time.

However, the present invention can reduce both an ME time and a texture encoding time. Of course, the amount of encoding slightly increases, but an increase in the amount of encoding is ignorable when the quantization coefficient is large. For example, when the quantization coefficient is 31, the conventional technique can encode approximately 12 4CIF frames, but the video encoder using the present invention can encode up to approximately 20 frames.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A motion estimation (ME) apparatus for predicting a motion vector (MV) through a process for comparing pixel values between a current frame image and a previous frame image, comprising:
a register block for registering MV prediction values and computational complexity parameters necessary for ME;
a frame memory block for storing at least one part necessary for the ME among pixel data of a previous frame and pixel data of a current frame;
a processing element (PE) block for receiving the pixel data from the frame memory block, performing the ME according to an ME mode decided by the computation complexity parameters received from the register block, comparing pixel values between the current and previous frames, computing a minimum sum of absolute differences (SAD) for a current macroblock, and selecting an MV corresponding to the minimum SAD;
an MV management block for receiving the MV prediction values from the register block, generating an MV with an SAD to be currently computed by the PE block, and managing and outputting the MV selected by the PE block; and
a state control block for controlling an overall operation of the blocks.

2. The ME apparatus of claim 1, further comprising:
a second PE block for computing a mean value of the pixel data for the current macroblock.

3. The ME apparatus of claim 1, wherein the MV prediction values used in macroblock-based ME comprise:
MV Prediction Value 0 of (MVPX0, MVPY0) corresponding to an MV value of a block located at (0, 0);
MV Prediction Value 1 of (MVPX1, MVPY1) corresponding to a median value between Prediction Values 2, 3, and 4;
MV Prediction Value 2 of (MVPX2, MVPY2) corresponding to an MV value of a block located in an up direction;
MV Prediction Value 3 of (MVPX3, MVPY3) corresponding to an MV value of a block located in an up/right diagonal direction; and
MV Prediction Value 4 of (MVPX4, MVPY4) corresponding to an MV value of a block located in a left direction, and
wherein the computation complexity parameters comprise:
a value EN4 indicating whether or not an operation associated with 4MV mode is performed;
a value LW4 indicating whether block-based ME around an MV found in the macroblock-based ME is performed for ±1 or ±2 pixels;
a value IPO indicating whether the ME is performed only for integer pixels; and
a value MEP indicating whether half-pixel ME is performed in 1MV or 4MV mode after the 1MV or 4MV mode is decided.

4. The ME apparatus of claim 1, wherein the PE block comprises:
a sampler for sampling half-pixel or integer-pixel data necessary for an SAD computation;
an SAD accumulator for accumulating a difference between the current frame image and the previous frame image, and obtaining an SAD corresponding to a current MV; and
a comparator for detecting a minimum SAD of SADs for MVs, and notifying the state control block of the detected minimum SAD.

5. The ME apparatus of claim 1, wherein the PE block computes SADs for MVs within ±2 pixels around five MV prediction values when an MV based on a macroblock is found, and selects the MV with the minimum SAD.

6. The ME apparatus of claim 1, wherein the MV management block comprises:
an MV checker block for checking whether or not an SAD to be currently computed for an MV has already been computed, and notifying the state control block of a result of the checking;
an MV generator block for generating an MV necessary for computing the current SAD in response to the MV prediction values, and providing the state control block with a signal indicating whether or not the MV with the SAD to be currently computed is outside a search range; and
an address encoder block for generating an address necessary for reading data from the frame memory block in relation to the generated MV with the current SAD.

7. A motion estimation (ME) method for predicting a motion vector (MV) through a process for comparing pixel values between a current frame image and a previous frame image, comprising the steps of:
(a) searching for a minimum sum of absolute differences (SAD) for a current macroblock and an MV corresponding to the minimum SAD, and computing a mean value between pixel data of the current macroblock;
(b) receiving computational complexity parameters, and performing an ME operation on a current frame image according to an ME mode decided by the computational complexity parameters; and
(c) outputting the minimum SAD for the current macroblock obtained after the ME operation and the MV corresponding to the minimum SAD.

8. The ME method of claim 7, wherein the step (a) comprises the steps of:
checking whether or not an SAD to be currently computed for an MV has already been computed;
generating the MV necessary for computing the current SAD according to MV prediction values; and
determining whether or not the MV with the SAD to be currently computed is outside a search range, on the basis of MV prediction values.

9. The ME method of claim 7, further comprising the steps of:
when an MV for a macroblock is found,
computing SADs for MVs within ±2 pixels around MV prediction values; and
selecting the MV with the minimum SAD.

10. The ME method of claim 7, wherein the computation complexity parameters comprise:
a value EN4 indicating whether or not an operation associated with 4MV mode is performed;
a value LW4 indicating whether block-based ME around an MV found in macroblock-based ME is performed for ±1 pixels or ±2 pixels;
a value IPO indicating whether the ME is performed only for integer pixels; and
a value MEP indicating whether half-pixel ME is performed in 1MV or 4MV mode after the 1MV or 4MV mode is decided.

11. The ME method of claim 8, wherein the MV prediction values used in macroblock-based ME comprise:
MV Prediction Value 0 of (MVPX0, MVPY0) corresponding to an MV value of a block located at (0, 0);
MV Prediction Value 1 of (MVPX1, MVPY1) corresponding to a median value between Prediction Values 2, 3, and 4;
MV Prediction Value 2 of (MVPX2, MVPY2) corresponding to an MV value of a block located in an up direction;
MV Prediction Value 3 of (MVPX3, MVPY3) corresponding to an MV value of a block located in an up/right diagonal direction; and
MV Prediction Value 4 of (MVPX4, MVPY4) corresponding to an MV value of a block located in a left direction.

12. The ME method of claim 7, further comprising the steps of:
when the value EN4 indicating whether or not an operation associated with 4MV mode is performed is input, deciding an ME mode if the value EN4 is 0; and
determining the value LW4 indicating whether block-based ME around an MV found in macroblock-based ME is performed for ±1 or ±2 pixels if the value EN4 is 1.

13. The ME method of claim 12, further comprising the steps of:
when the value LW4 indicating whether the block-based ME around the MV found in the macroblock-based ME is performed for ±1 or ±2 pixels is input, performing ME for 4 luminance blocks of the current macroblock if the value LW4 is 1, the ME being performed for ±1 pixels around the MV found by the macroblock-based ME;
performing ME for the 4 luminance blocks of the current macroblock if the value LW4 is 0, the ME being performed for ±2 pixels around the MV found by the macroblock-based ME; and
deciding the ME mode after the block-based ME.

14. The ME method of claim 12, wherein the step of deciding the ME mode comprises the steps of:
deciding the ME mode to be an intra-mode if A<(SAD−THR_{INTRA}) is true; and
deciding the ME mode to be an inter-mode if A<(SAD−THR_{INTRA}) is false, where A is defined as
$$A = {\sum }_{i = 0 , j = 0}^{15 , 15} \vert {C}_{i , j} - MB\_mean \vert ,$$
a pixel means value for the current macroblock MB_mean is defined as
$$MB\_mean = ( {\sum }_{i = 0 , j = 0}^{15 , 15} {C}_{i , j} ) / 256 ,$$
C_{i,j} is a pixel value of a current frame, and THR_{INTRA} is a value capable of being set by a user.

15. The ME method of claim 14, further comprising the steps of:
terminating the ME operation, when the ME mode is decided to be the intra-mode; and
determining an input of the value IPO indicating whether or not the ME is performed only for integer pixels among the computational complexity parameters, when the ME mode is decided to be the inter-mode.

16. The ME method of claim 15, further comprising the steps of:
when the value IPO indicating whether or not the ME is performed only for integer pixels is input, performing the ME only for integer pixels if the value IPO is 1, deciding 1MV or 4MV mode by means of
$${SAD}_{16} < {\sum }_{4 blocks} {SAD}_{8} - {THR}_{1 MV} ,$$
and performing the ME in the decided mode, where SAD₁₆ is an SAD produced from a result of macroblock-based ME, SAD₈ is an SAD produced from a result of block-based ME, and THR_{1MV} is an arbitrary value set by the user; and
determining an input of a value MEP indicating whether or not half-pixel ME is performed in the 1MV or 4MV mode among the computational complexity parameters after the 1MV or 4MV mode is determined before the half-pixel ME, if the IPO is 0.

17. The ME method of claim 16, further comprising the steps of:
when the value MEP indicating whether the half-pixel ME is performed in the 1MV or 4MV mode is input after the 1MV or 4MV mode is determined before the half-pixel ME,
deciding the 1MV or 4MV mode by means of
$${SAD}_{16} < {\sum }_{4 blocks} {SAD}_{8} - {THR}_{1 MV}$$
if the value MEP is 1, and performing the half-pixel ME in the decided mode, where SAD₁₆ is an SAD produced from a result of macroblock-based ME, SAD₈ is an SAD produced from a result of block-based ME, and THR_{1MV} is an arbitrary value set by the user;
performing the half-pixel ME based on a macroblock unit if the value MEP is 0, and determining the value EN4 indicating whether or not an operation associated with 4MV mode is performed;
performing the half-pixel ME based on a block unit if the value EN4 is 1; and
performing an operation associated with the 1MV mode if the value EN4 is 0, and deciding the 1MV or 4MV mode by means of
$${SAD}_{16} < {\sum }_{4 blocks} {SAD}_{8} - {THR}_{1 MV}$$
if the value MEP is 1, and performing the half-pixel ME in the decided mode, where SAD₁₆ is an SAD produced from a result of macroblock-based ME, SAD₈ is an SAD produced from a result of block-based ME, and THR_{1MV} is an arbitrary value set by the user.

18. A method for adjusting a motion estimation (ME) time and a texture encoding time in a video encoder for simultaneously performing motion estimation (ME) and texture encoding using a macroblock-based pipeline structure, the video encoder performing ME for Macroblock 0, simultaneously performing ME for Macroblock 1 and texture encoding for Macroblock 0, and simultaneously performing ME for Macroblock 2 and texture encoding for Macroblock 1, the method comprising:
receiving computational complexity parameters defining a plurality of ME mode; and
adjusting the ME time and the texture encoding time by increasing or decreasing the number of ME computations for a current frame image in response to the computational complexity parameters.

19. The method of claim 18, wherein the computational complexity parameters comprise:
a value EN4 indicating whether or not an operation associated with 4MV mode is performed;
a value LW4 indicating whether block-based ME around an MV found in macroblock-based ME is performed for ±1 or ±2 pixels;
a value IPO indicating whether the ME is performed only for integer pixels; and
a value MEP indicating whether half-pixel ME is performed in 1MV or 4MV mode after the 1MV or 4MV mode is decided.
